(19) United States
(12) Patent Application Publication
(10) Pub. No.: US 2020/0328557 A1
(43) Pub. Date: Oct. 15, 2020

(54) OPEN-ENDED MAGNETIC ATTRACTION CHARGING DEVICE FOR ELECTRONIC CIGARETTE

(71) Applicant: Stage One Brands Limited, Hong Kong (CN)

(72) Inventor: I-Chen Liu, Hong Kong (CN)

(21) Appl. No.: 16/383,668

(22) Filed: Apr. 15, 2019

(51) Int. Cl. H01R 13/62; H02J 7/00; H01R 13/72; A24F 47/00

(52) U.S. Cl. CPC H01R 13/6205; H02J 7/0044; H02J 7/0027; A24F 47/008; H01R 13/72

(57) ABSTRACT

An open-ended magnetic attraction charging device for an electronic cigarette includes a main body. A circuit board is disposed in the main body. The circuit board is connected with a power receiving end for connecting an external power source and a charging end for charging an electronic cigarette in a plane contact manner. The charging device has an ingenious and reasonable structure, realizes an open-ended charging design, and can match electronic cigarette charging interfaces of different sizes, solves the problem that the charging device is prone to overbalance, and improves the user experience.

### BACKGROUND OF THE INVENTION

### 1. Field of the Invention

The present invention relates to a charging device, and more particularly to an open-ended magnetic attraction charging device for an electronic cigarette.

### 2. Description of the Prior Art

A conventional electronic cigarette is usually charged by disassembling the battery of the electronic cigarette and then plugging it into a cylindrical charging device for charging. The batteries of different sizes for electronic cigarettes need to be matched with different charging devices, resulting in poor applicability of the charging device for electronic cigarettes. The charging device of the conventional electronic cigarette is prone to overbalance when charging, which affects the user experience.

The internal structure of the charging device of the conventional electronic cigarette is poor to affect the stability of the overall structure of the charging device. In addition, the charging device is large in size, which is inconvenient for people to store and carry the charging device of the electronic cigarette. Accordingly, the inventor of the present invention has devoted himself based on his many years of practical experiences to solve these problems.

### SUMMARY OF THE INVENTION

In view of the shortcomings of the prior art, the primary object of the present invention is to provide an open-ended magnetic attraction charging device for an electronic cigarette, which has an ingenious and reasonable structure, realizes an open-ended charging design, and can match electronic cigarette charging interfaces of different sizes, solves the problem that the charging device is prone to overbalance, and improves the user experience.

In order to achieve the above object, the present invention adopts the following technical solutions:

An open-ended magnetic attraction charging device for an electronic cigarette comprises a main body. A circuit board is disposed in the main body. The circuit board is connected with a power receiving end for connecting an external power source and a charging end for charging an electronic cigarette in a plane contact manner. The main body has a planar charging area for charging the electronic cigarette. The charging end is exposed to the planar charging area. The planar charging area is provided with a charging magnetic attraction area for attracting the electronic cigarette. A weight for increasing the weight of the charging device is disposed in the main body.

The present invention has obvious advantages and beneficial effects compared with the prior art. Specifically, it can be known from the above technical solutions:

The planar charging area provided on the main body can be applied to electronic cigarette charging interfaces of different sizes, thereby realizing an open-ended charging design and improving the applicability and versatility greatly. This is favorable for popularization and use. The charging magnetic attraction area provided in the planar charging area is provided with a magnetic positioning structure to facilitate the charging and positioning of the electronic cigarette. The weight provided in the main body is configured to increase the entire weight of the charging device. The center of gravity of the charging device can be flexibly adjusted by using the weight, thereby solving the problem that the charging device is prone to overbalance and improving the user experience.

### BRIEF DESCRIPTION OF THE DRAWINGS

FIG. 1 is a perspective view of a first embodiment of the present invention;

FIG. 2 is another perspective view of the first embodiment of the present invention;

FIG. 3 is an exploded view of the first embodiment of the present invention;

FIG. 4 is another exploded view of the first embodiment of the present invention;

FIG. 5 is a cross-sectional view of the first embodiment of the present invention;

FIG. 6 is a perspective view of a second embodiment of the present invention;

FIG. 7 is an exploded view of the second embodiment of the present invention;

FIG. 8 is another exploded view of the second embodiment of the present invention;

FIG. 9 is a further exploded view of the second embodiment of the present invention;

FIG. 10 is a yet further exploded view of the second embodiment of the present invention; and

FIG. 11 is a cross-sectional view of the second embodiment of the present invention.

### DETAILED DESCRIPTION OF THE PREFERRED EMBODIMENTS

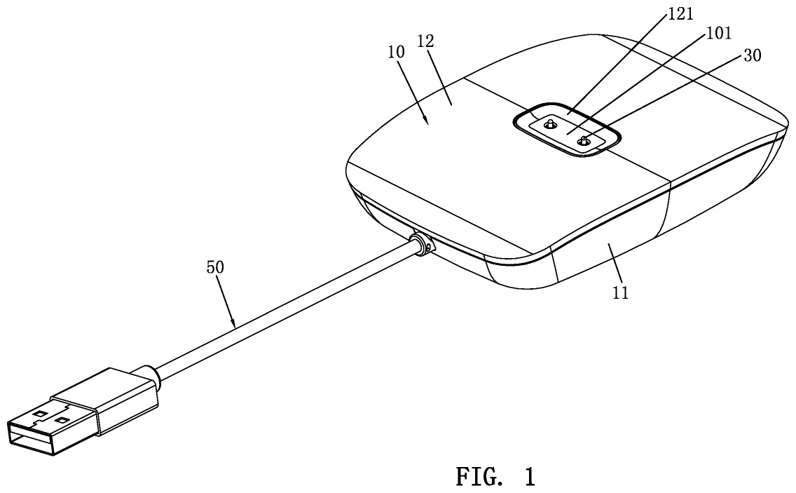

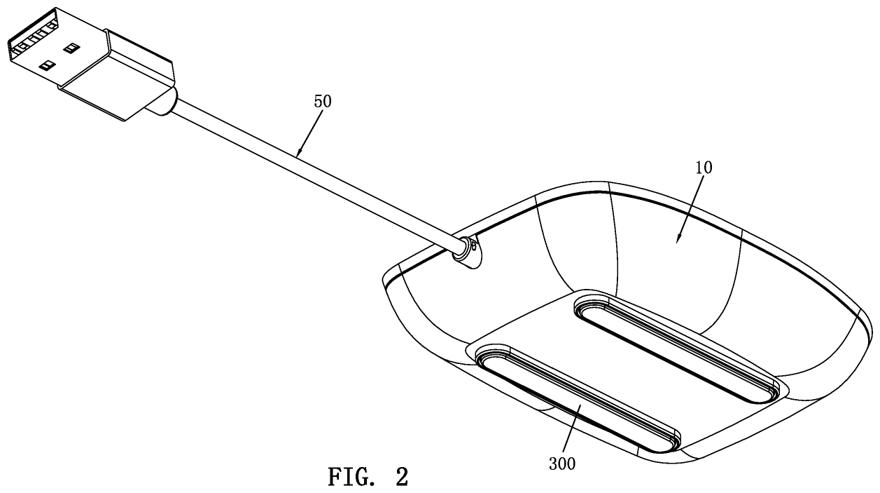

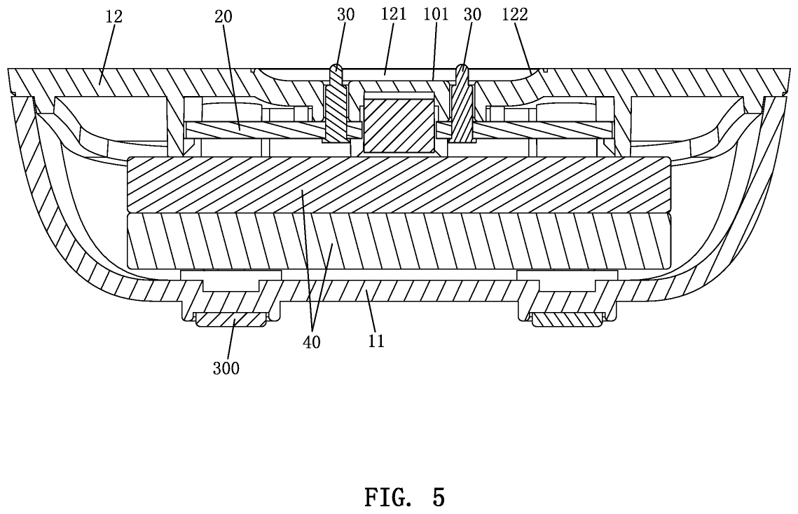

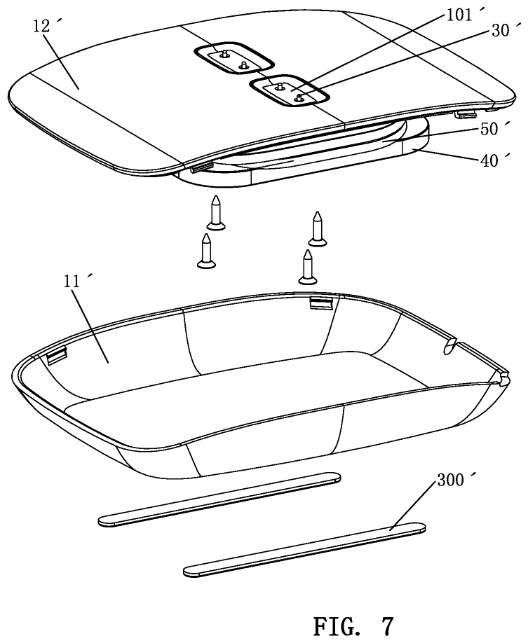

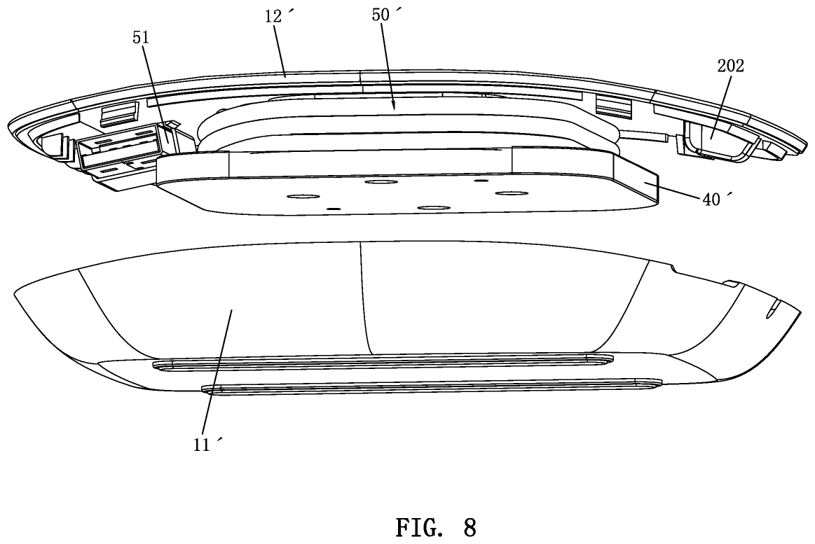

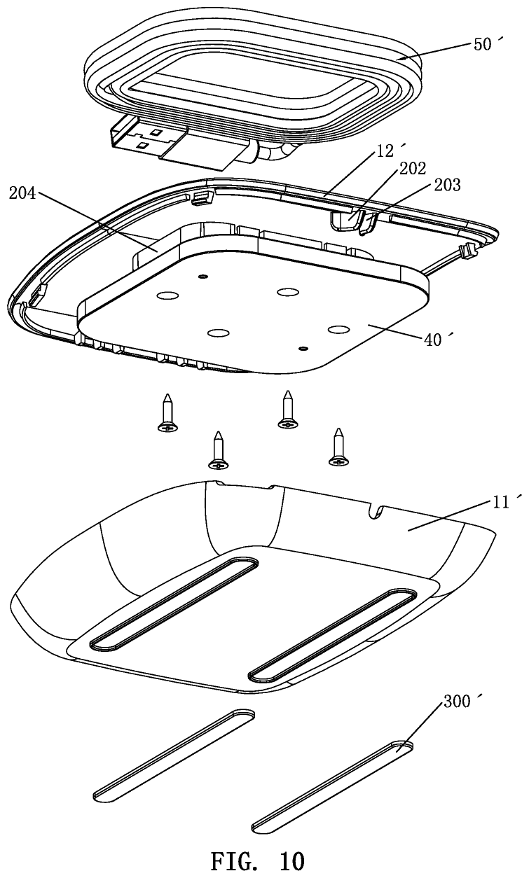

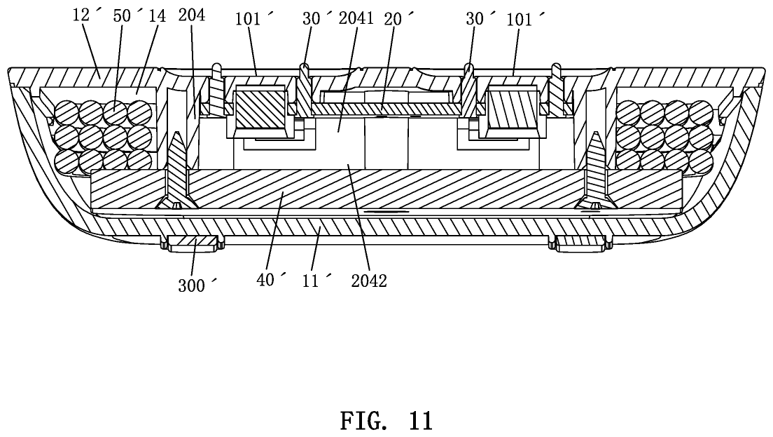

Referring to FIG. 1 through FIG. 11, there are shown specific structures of two embodiments of the present invention.

First, please refer to FIG. 1 to FIG. 5, which shows the specific structure of a first embodiment of the present invention.

An open-ended magnetic attraction charging device for an electronic cigarette comprises a main body 10. A circuit board 20 is disposed in the main body 10. The circuit board 20 is connected with a power receiving end for connecting an external power source and a charging end 30 for charging an electronic cigarette in a plane contact manner. The main body 10 has a planar charging area 101 for charging the electronic cigarette. The charging end 30 is exposed to the planar charging area 101. The planar charging area 101 is provided with a charging magnetic attraction area for attracting the electronic cigarette. A weight 40 for increasing the weight of the charging device is disposed in the main body 10 to prevent the charging device from overbalancing during use.

The main body 10 includes a bottom casing 11 and a top cover 12 that is disposed on the bottom casing 11. The planar charging area 101 is formed on the upper surface of the top cover 12. The charging end 30 is exposed to the upper surface of the top cover 12. The charging magnetic attraction area is disposed on the upper surface of the top cover 12. The upper surface of the top cover 12 is recessed downwardly to form a charging recess 121 for charging the electronic cigarette. The planar charging area 101 is the bottom surface of the charging recess 121. The charging end 30 is exposed to the charging recess 121. The charging magnetic attraction area is disposed in the charging recess 121. Preferably, the charging recess 121 is provided with a curved circumferential wall 122. The upper and lower ends of the curved circumferential wall 122 are connected to the upper surface of the top cover 12 and the bottom surface of the charging recess 121, respectively.

Preferably, the charging end 30 is a charging elastic needle that is telescopic to match the positioning of the electronic cigarette. Preferably, the underside of the bottom casing 11 is provided with a protective pad 300. The protective pad 300 is exposed to the underside of the bottom casing 11 for protecting the outer casing of the main body 10.

Preferably, the power receiving end is a power input data cable 50. The power input data cable 50 is electrically connected to the circuit board 20. In the first embodiment, one end of the power input data cable 50 is located inside the main body 10, and another end of the power input data cable 50 is located outside the main body 10.

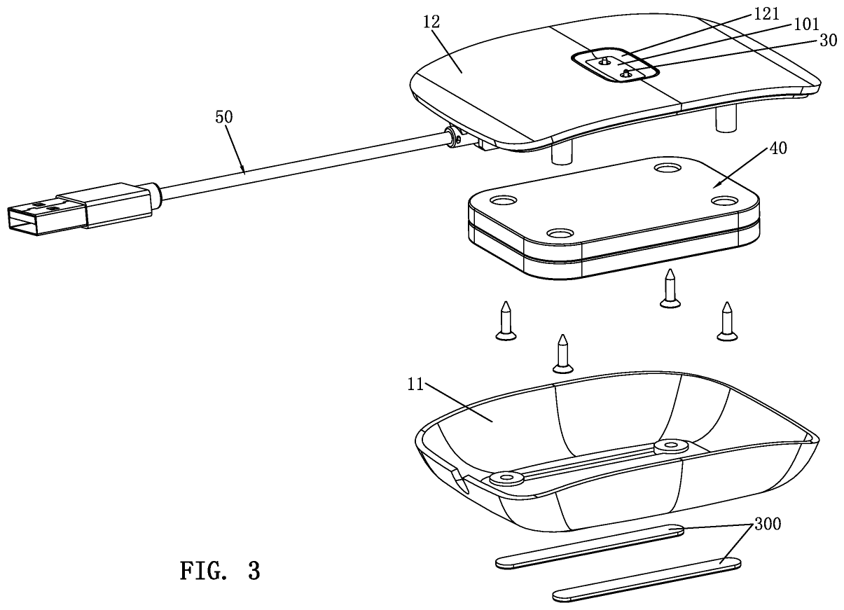

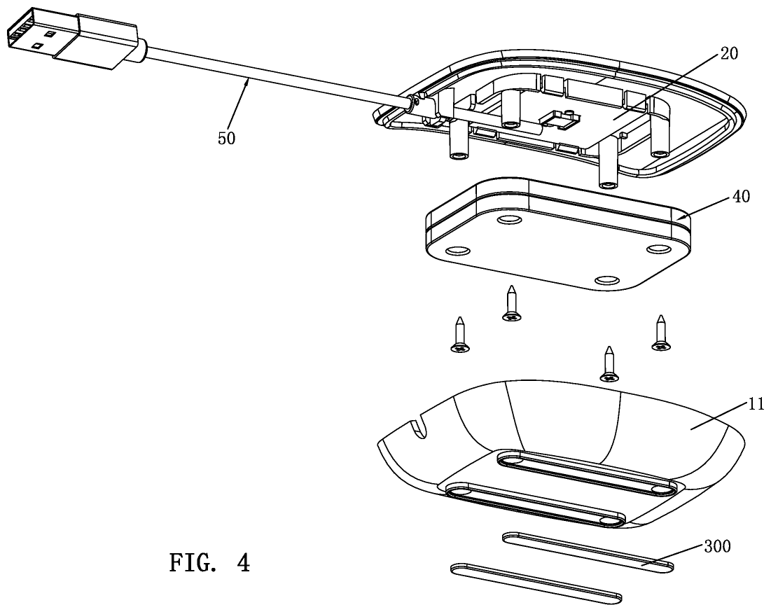

In the first embodiment, the structure and arrangement of the circuit board 20 and the weight 40 are reasonable. Specifically, as shown in FIG. 3 and FIG. 4, the weight 40 is located below the circuit board 20. The bottom casing 11 of the main body 10 is provided with a mounting through hole. The top cover 12 has a positioning post extending downwardly. A connecting screw hole is defined in the positioning post. A positioning hole is formed in the weight 40. The positioning post is inserted into the positioning hole, and then a screw is inserted through the mounting through hole and then connected to the connecting screw hole. The protective pad 300 is disposed at the bottom of the bottom casing 11 to cover the outer end of the screw. The protective pad 300 serves as a bottom foot for the entire charging device.

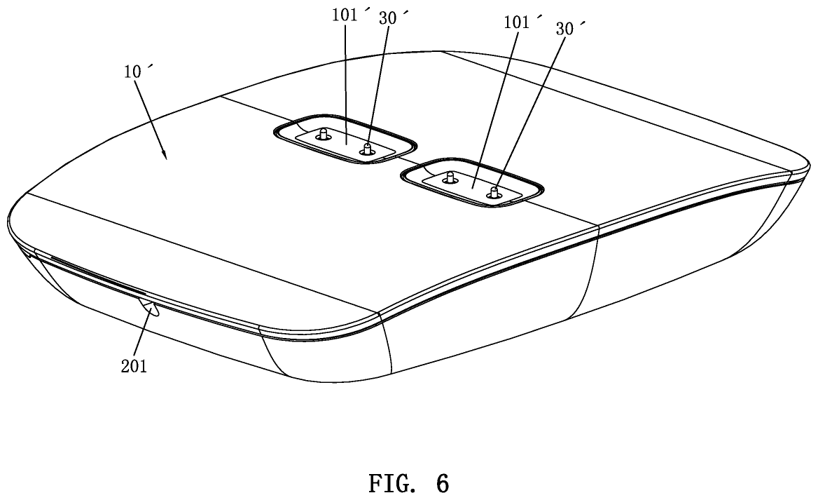

Next, please refer to FIG. 6 to FIG. 11, which shows the specific structure of a second embodiment of the present invention.

The second embodiment is substantially similar to the first embodiment, and the main differences are: (1) the setting of the power input data cable; (2) the assembly of the top cover and the bottom casing, and the positioning of the weight. Next, the differences are described below.

(1) The power input data cable 50′ of the second embodiment is wound in the main body 10′.

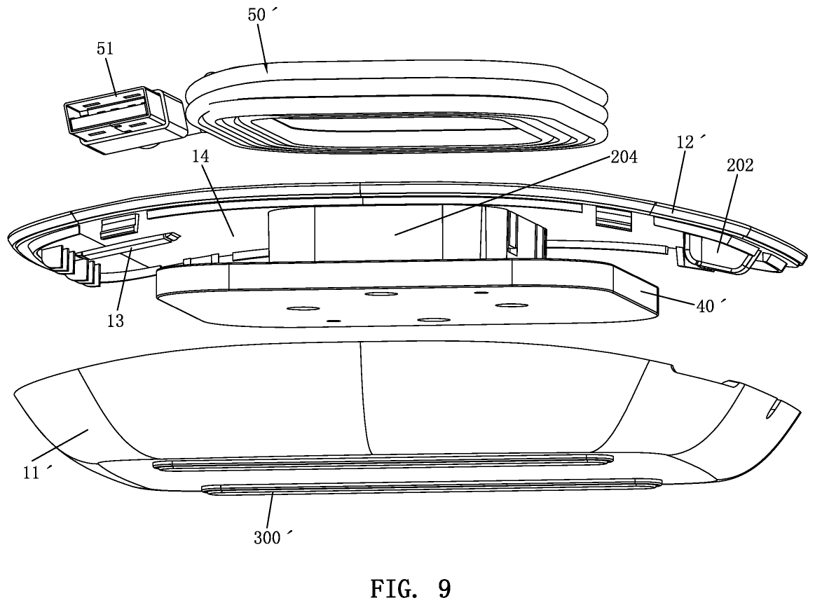

A mounting portion 204 is disposed beneath the top cover 12′. The mounting portion 204 has a mounting cavity 2041 and an opening 2042 facing downwardly and communicating with the mounting cavity 2041. The circuit board 20′ is mounted in the mounting cavity 2041. The weight 40′ is located below the circuit board 20. The upper end of the weight 40′ is limited by the lower end of the mounting portion 204. A winding portion 14 for winding the power input data cable is disposed in the main body 10′. The power input data cable 50′ is wound around the winding portion 14. In this embodiment, the outer side of the mounting portion 204 is defined as the winding portion 14. As shown in FIG. 9, the power input data cable 50′ is wound around the outside of the mounting portion 204. An accommodating cavity for winding is defined among the lower side of the top cover 12′, the upper side of the weight 40′, and the outer side of the mounting portion 204. A positioning magnetic attraction portion 13 for attracting and positioning a connector 51 of the power input data cable is disposed beneath the top cover 12′. The connector 51 of the power input data cable 50′ is detachably attracted and positioned on the positioning magnetic attraction portion 13, so that the connector 51 of the power input data cable 50′ can be stably positioned in the main body 10′.

(2) The bottom casing 11′ of the second embodiment is detachably connected to the underside of the top cover 12′.

The junction of the bottom casing 11′ and the top cover 12′ is formed with a cable outlet 201 for extending the power input data cable. A cable guiding portion is disposed beneath one end of the top cover 12. The cable guiding portion includes two spaced guiding walls 202. A guiding groove 203 is defined between the two guiding walls 202. The guiding groove 203 is in communication with the cable outlet 201.

The weight 40′ is connected to the top cover 12′ to be one-piece. The screw is connected to the weight 40′ and the positioning post, and the screw is covered by the bottom casing 11′. As shown in FIG. 6 to FIG. 8, when it is required to use the power input data cable 50′, the bottom casing 11′ is opened first, and the connector 51 of the power input data cable 50′ is disengaged from the positioning magnetic attraction portion 13 to be pulled out, and then the bottom casing 11′ is buckled again. In use, the connector 51 located outside the cable outlet 201 is pulled as needed, and the required length of the power input data cable 50′ can be flexibly controlled.

In addition, it should be noted that the second embodiment shows two charging recesses, and the first embodiment shows a charging recess. In fact, the charging recesses may be provided in accordance with actual requirements. Accordingly, the charging end, the planar charging area, and the charging magnetic attraction area are all plural. The layout of the charging recess may be determined according to actual requirements, and is not limited to the layout shown in the first embodiment or the second embodiment.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An open-ended magnetic attraction charging device for an electronic cigarette, comprising a main body, a circuit board being disposed in the main body, the circuit board being connected with a power receiving end for connecting an external power source and a charging end for charging an electronic cigarette in a plane contact manner; the main body having a planar charging area for charging the electronic cigarette, the charging end being exposed to the planar charging area, the planar charging area being provided with a charging magnetic attraction area for attracting the electronic cigarette;
a weight for increasing the weight of the charging device being disposed in the main body.

2. The open-ended magnetic attraction charging device as claimed in claim 1, wherein the main body includes a bottom casing and a top cover that is disposed on the bottom casing; the planar charging area is formed on an upper surface of the top cover, the charging end is exposed to the upper surface of the top cover, and the charging magnetic attraction area is disposed on the upper surface of the top cover.

3. The open-ended magnetic attraction charging device as claimed in claim 2, wherein the upper surface of the top cover is recessed downwardly to form a charging recess for charging the electronic cigarette, the planar charging area is a bottom surface of the charging recess, the charging end is exposed to the charging recess, and the charging magnetic attraction area is disposed in the charging recess.

4. The open-ended magnetic attraction charging device as claimed in claim 3, wherein the charging recess is provided with a curved circumferential wall, upper and lower ends of the curved circumferential wall are connected to the upper surface of the top cover and the bottom surface of the charging recess, respectively.

5. The open-ended magnetic attraction charging device as claimed in claim 2, wherein the power receiving end is a power input data cable, and the power input data cable is electrically connected to the circuit board.

6. The open-ended magnetic attraction charging device as claimed in claim 5, wherein one end of the power input data cable is located inside the main body, and another end of the power input data cable is located outside the main body.

7. The open-ended magnetic attraction charging device as claimed in claim 5, wherein the power input data cable is wound in the main body, a winding portion for winding the power input data cable is disposed in the main body, the power input data cable is wound around the winding portion, a positioning magnetic attraction portion for attracting and positioning a connector of the power input data cable is disposed beneath the top cover, and the connector of the power input data cable is detachably attracted and positioned on the positioning magnetic attraction portion.

8. The open-ended magnetic attraction charging device as claimed in claim 7, wherein the bottom casing is detachably connected to the top cover, a junction of the bottom casing and the top cover is formed with a cable outlet for extending the power input data cable, a cable guiding portion is disposed beneath one end of the top cover, the cable guiding portion includes two spaced guiding walls, a guiding groove is defined between the two guiding walls, and the guiding groove is in communication with the cable outlet.

9. The open-ended magnetic attraction charging device as claimed in claim 7, wherein the weight is fixed beneath the top cover through a screw, and the winding portion is formed between the weight and the top cover.

10. The open-ended magnetic attraction charging device as claimed in claim 2, wherein a mounting portion is disposed beneath the top cover, the mounting portion has a mounting cavity and an opening facing downwardly and communicating with the mounting cavity, the circuit board is mounted in the mounting cavity; the weight is located below the circuit board, and an upper end of the weight is limited by a lower end of the mounting portion.
